(19) United States
(12) Patent Application Publication
(10) Pub. No.: US 2003/0107990 A1
(43) Pub. Date: Jun. 12, 2003

(54) System and method for determining a quality of service

(76) Inventors: Garrette Herschleb, Longmont, CO (US); Richard Gordon Jobson, Monument, CO (US)

Correspondence Address: Law Offices of Dale B. Halling, Suite 311, 24 South Weber St., Colorado Springs, CO, 80903, US

(21) Appl. No.: 10/021,853

(22) Filed: Dec. 12, 2001

(51) Int. Cl. H04J 1/16; H04J 3/14

(52) U.S. Cl. 370/229; 370/252

(57) ABSTRACT

A system for determining a quality of service has a plurality of passive probes attached to a plurality of network connections in the packet communication network. A collector correlator is in communication with the plurality of probes. The collector correlator determines a dropped packets measurement. The collector correlator may also determine a flow to monitor.

### FIELD OF THE INVENTION

The present invention relates generally to the field of communication systems and more particularly to a system and method for determining a quality of service.

### BACKGROUND OF THE INVENTION

Communication networks commonly carry information or objects in packages (“packets”). These networks are subject to variations and degradations in their quality of service. Degradation in the quality of service may be the result of packets being discarded while in transit (dropped packets), excessive time in transit (delay), variance in the transit time of packets (jitter), and packets not arriving in the order transmitted (re-ordering). These problems may be caused by a number of underlying problems, such as the demands exceeding the capability of the resources, an interruption in a carrier line, a breakdown of equipment in the network, or improper operation of equipment in the network. Resources may be limited by the capacity of a router or of a carrier line. Being able to accurately measure the quality of service is important to carriers so they can quickly fix network problems and important to customers so they are not over paying for services and know if the service will meet their needs. One solution to measuring the quality of service has been to send pings between end points on the network. This type of system is referred to as an active measurement. Unfortunately, some networks treat pings differently than other types of traffic. One solution has been to create different types of pings to mimic these other types of traffic. At some point these pings add to the traffic on the network and a result do not measure how the traffic would behave without the pings. In addition, the overhead traffic is reducing the bandwidth for the customers using the network.

Thus there exists a need for a method and system that can measure the quality of service of a network passively without adding in-band overhead to the network.

### BRIEF DESCRIPTION OF THE DRAWINGS

FIG. 1 is a block diagram of a system for determining a quality of service in accordance with one embodiment of the invention;

FIG. 2 is a block diagram of a probe in accordance with one embodiment of the invention;

FIG. 3 is a block diagram of a collector correlator in accordance with one embodiment of the invention; and

FIG. 4 is a flow chart of the steps used in a method of determining a quality of service in accordance with one embodiment of the invention.

### DETAILED DESCRIPTION OF THE DRAWINGS

A system for determining a quality of service has a plurality of passive probes attached to a plurality of network connections in the packet communication network. A collector correlator is in communication with the plurality of probes. The collector correlator determines a dropped packets measurement. In one embodiment, the collector correlator determines a flow to monitor. Since the system uses passive probes, it does not add significant or any overhead to the data traffic on the packet communication network. In addition, the system efficiently measures the quality of service by defining the flow or flows the probes are to monitor.

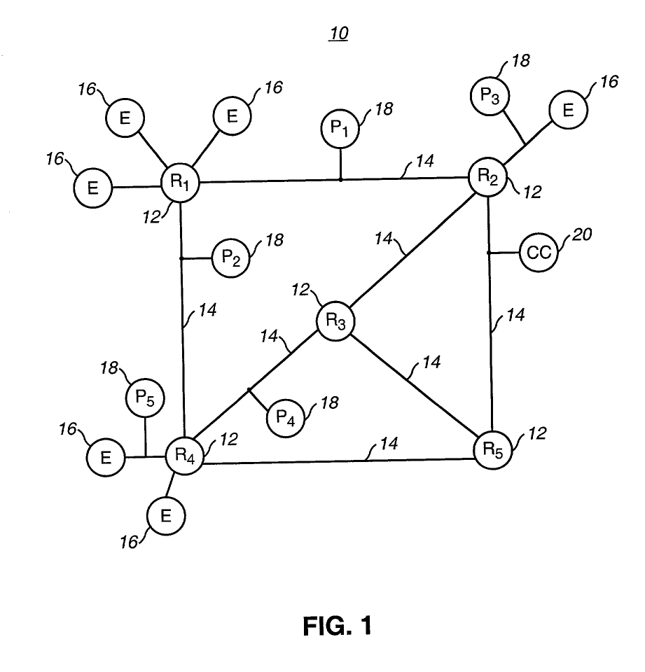

FIG. 1 is a block diagram of a system 10 for determining a quality of service in accordance with one embodiment of the invention. The system 10 measures the quality of service of a packet communication network having a plurality of routers (R) 12 and a plurality of network connections 14. Access points and network peers (E) 16 may be connected to certain of the routers 12. In order to measure the quality of service of the network a plurality of passive probes (at least two passive probes) 18 are attached to the plurality of network connections (at least two network connections) 14. The passive probes 18 are controlled by and send data to a collector correlator (CC) 20. The collector correlator 20 computes a number of quality of service measurements such as dropped packets, delay time, jitter and packet reordering. The collector correlator 20 is connected to the packet communication network in this case. In one embodiment, the collector correlator 20 is not connected to the communication network and a separate communication system is used to connect to the probes. The communication system is shown as a packet based network, however the system can work with non-packet based communication systems.

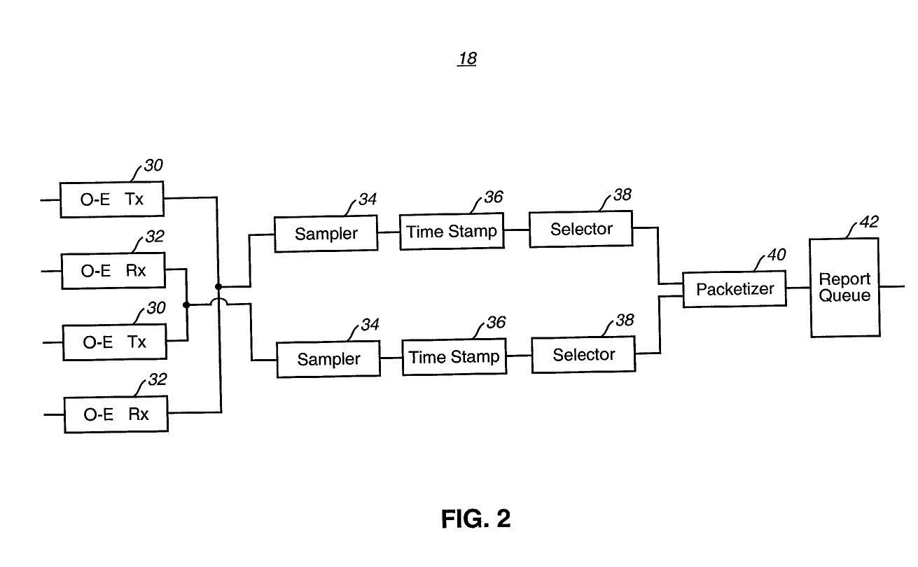

FIG. 2 is a block diagram of probe 18 in accordance with one embodiment of the invention. The probe 18 has a pair of electrical to optical transmitters (Tx) 30 and a pair of optical to electrical receivers 32. This allows the probe to passively monitor traffic in both directions. In one embodiment, the probe contains standard electrical receivers and transmitters. In another embodiment, the probe may contain wireless receivers and transmitters. The transmitter receiver pairs are connected to a pair of samplers 34. The samplers 34 select the portions of the incoming packets that are necessary to determine if the packet belongs to a flow that the collector correlator has directed it to monitor. The samplers 34 are connected to a pair of time stamps (time stamp subsystem) 36. The time stamps 36 are connected to a universal common clock. In one embodiment, the universal common clock is accomplished by having GPS receivers at each probe, however other clocking systems are possible. The time stamps 36 are connected to the selector 38. The selector 38 determines if a packet is part of a flow being monitored. When a packet is part of a flow being monitored a unique identifier is created by the selector 38 for the packet. The unique identifier may include a flow identifier and a sequence identifier. The selectors 38 are connected to a packetizer 40. The probe packetizer 40 forms reports or report packets. The report packets are held for transmission in a report queue 42.

A probe 18 receives and retransmits every packet along a network connection. The probe 18 will only sample packets in a flow selected by the collector correlator 20. A flow may be defined by a variety of parameters such as: to and from addresses (pair of addresses); by a port number; and/or by a type of protocol. This allows the system to define the quality of service for different portions of the network as well as for different transmission protocols. The probe creates a report packet for every packet in a flow that it is directed to monitor. The report packet may contain the following information: request serial number; a flow identifier; a timestamp; a direction and a sequence identifier. The request serial number is the serial number associated with a request from the collector correlator. The flow identifier defines the flow being monitored and is usually defined by the collector correlator. Note that a request may require a probe to monitor multiple flows. The timestamp may be an absolute time or a relative time the packet was received at the probe. The sequence identifier may define the protocol of the flow. In addition, the sequence identifier will define where this packet is in a flow. Once the report packet is formed it is passed to a report queue 42 to await transmission to the collector correlator. The user may define when report packets are to be transmitted. This is especially important when the report packets are sent on the same network as the traffic packets. The user may define a time of day that the probe is allowed to transmit report packets or based on a utilization level of the network (network connection) or by real time flow control from the collector correlator of by external stimui. In another embodiment, the probe may be directed to store reports until a minimum number are collected or to discard more than a certain number of packets. The discard strategy may be to discard the latest, oldest, interleaved or least relevant.

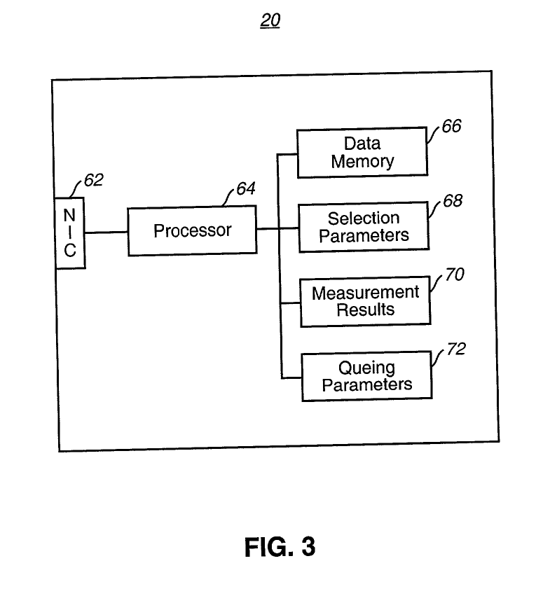

FIG. 3 is a block diagram of a collector correlator 20 in accordance with one embodiment of the invention. The collector correlator 20 has a network interface card (NIC) 62 that allows it to communicate with the probes. The network interface card 62 is connected to a processor 64. The processor 64 is connected to a data memory 66, selection parameters 68, measurement results 70 and queuing parameters 72. The data memory 66 holds raw results from the probes. The selection parameters 68 define which flows the probes are directed to monitor. The user may invoke several types of monitoring. For instance, the user may select no user input and then the collector correlator will select flows based on a random sampling of flows at the probes. In another embodiment the user may influence the random selection of flows by increasing or decreasing the chance of certain flows being selected. The user may target flows by network addresses, by selecting flows known to have quality of service concerns or flows having a specific layer five protocol. In another embodiment, the user may completely define a flow to be monitored. Finally the user may select some combination of the above choices.

The measurement results 70 include a dropped packets measurement, a time delay measurement and a jitter measurement. These measurements can be easily computed from the information in the report packets. Queuing parameters define how and when the probes are to transmit reports. The user may define when report packets are to be transmitted. This is especially important when the report packets are sent on the same network as the traffic packets. The user may define a time of day that the probe is allowed to transmit report packets or based on a utilization level of the network (network connection). In another embodiment, the probe may be directed to store reports until a minimum number are collected or to discard when more than a certain number of packets have collected. The discard strategy may be to discard the latest, oldest, interleaved or least relevant.

The collector correlator 20 transmits control information packets to the probes. The control information packets determine which flows to monitor at the probes and how to transmit the report back to the collector correlator.

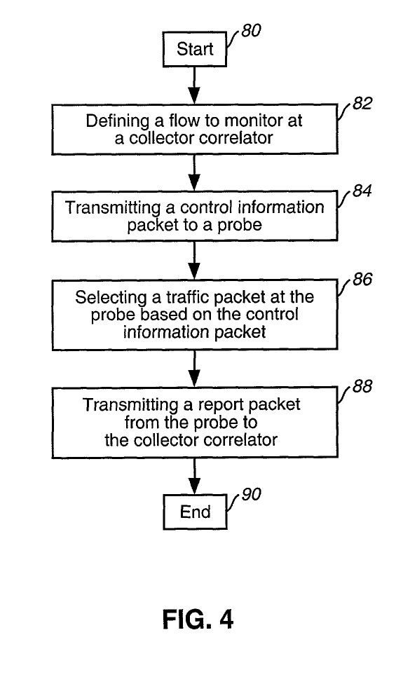

FIG. 4 is a flow chart of the steps used in a method of determining a quality of service in accordance with one embodiment of the invention. The process starts, step 80, by defining a flow to monitor at a collector correlator at step 82. A control information packet is transmitted to a probe at step 84. A traffic packet at the probe is selected base on the control information packet at step 86. At step 88 a report packet is transmitted from the probe to the collector correlator which ends the process at step 90. In one embodiment, the collector correlator randomly selects the flows to monitor. In another embodiment, a user input defines a flow to monitor. A pair of packet addresses are used to define the flow in one embodiment. In another embodiment, the user may select a port number or a type of protocol. The user or collector correlator may define a subset of the plurality of probes to monitor a flow.

In one embodiment the probe determines a time the traffic packet was detected. In another embodiment, the control information includes report queue information. The report queue information may define a time of day that reports are to be sent to the collector correlator. In addition, the report queue information may define a queue length or a discard rule. The queue length would tell the probe not to send any report packets until so many traffic packets had been selected. In another embodiment, the maximum queue length may be defined and additional report packets result in some packets being discarded. The invention is able to accommodate any standard queuing system.

The above queuing systems may mean that data may not be available for every packet. In addition, it may be desirable to provide quality of service information without having a probe 18 on every link 14 (see FIG. 1). Thus we have three categories of partial data: 1) Non-instrumented links; and 2) Missing reports from instrumented links; and 3) Non-absolute timestamps from some or all probes. For one to measure the QoS performance of a router with absolute resolution and certainty, all interfaces should be monitored. However, very reasonable approximations can be made about a routers QoS performance without having any of its interfaces directly measured. This is done by common path correlation, shown in FIG. 1.

Let Q be a quality of service index, encompassing operational quality of service parameters such as delay, jitter, dropped packets, and resequencing. Lower numbers represent higher quality of service. Qᵢ=Quality of Service experienced through a router Rᵢ. Q_{A,B,C, . . .} is the quality of service experienced across paths A, B, C, and so on.

Referring to the example in FIG. 1:

Path A goes through routers R1 and R2

Q_{A}=Q₁+Q₂

Path B goes through routers R4, R3 and R2

Q_{B}=Q₄₊Q₃+Q₂

Path C goes through routers R4, R5 and R2

Q_{C}=Q₄+Q₅+Q₂

By definition Q>=0. Therefore:

Q₂<=Q_{A}

Q₄<=Q_{B}

From the inequalities above, we can prove that:

Q₅>=Q_{C}−Q_{B}−Q_{A}

If Q_{A,B} are low and Q_{C} is high, Q₅ will compute to have a high minimum known value, showing that the real problem router in this example network is R₅, information we can compute without having instrumented any interfaces on the router R₅.

Q may be a figure representing delay, dropped packets, jitter, resequenced packets, or some composite index of any of these measurements.

If a report on a packet on a measured link is discarded, correlation for delay and jitter may still take place, but dropped packet and resequencing analysis is invalidated for packets reported between the last packet reported from that probe to the packet report with the discard warning flag set.

In the case of packet reports coming back with no absolute timestamp, only one-way delay computation is invalidated in computations involving those probes with relative-only timestamps.

Thus there has been described a system and method for determining a quality of service that provides a number of different measurements. In addition, the system uses passive probes that do not add packets to the network traffic to measure the network's performance. The queuing options allow the system to send report information when there is little traffic on the network or the system may use a separate channel (network) to send report information.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for determining a quality of service, comprising:
a plurality of passive probes attached to a plurality of network connections in a packet communication network; and
a collector correlator in communication with the plurality of probes, the collector correlator determining a dropped packets measurement.

2. The system of claim 1, wherein the collector correlator measures a delay time.

3. The system of claim 1, wherein the collector correlator measures a jitter.

4. The system of claim 1, wherein each of the plurality of passive probes has a sampler.

5. The system of claim 1, wherein each of the plurality of passive probes has a time stamp subsystem.

6. The system of claim 1, wherein each of the plurality of passive probes has a probe packetizer.

7. The system of claim 1, wherein the collector correlator transmits a control information packet.

8. The system of claim 1, wherein one of the plurality of probes transmits a report packet.

9. The system of claim 1, wherein the collector correlator is capable of calculating a quality of service without monitoring every network connection.

10. A method of determining a quality of service, comprises the steps of:
a) defining a flow to monitor at a collector correlator;
b) transmitting a control information to a probe;
c) selecting a traffic packet at the probe based on the control information packet; and
d) transmitting a report from the probe to the collector correlator.

11. The method of claim 10, wherein step (a) further includes the step of:
a1) randomly selecting the flow to monitor.

12. The method of claim 10, wherein step (a) further includes the step of:
a1) receiving a user input defining the flow to monitor.

13. The method of claim 10, wherein step (a) further includes the step of:
a1) defining a pair of packet addresses.

14. The method of claim 10, wherein step (a) further includes the step of:
a1) selecting a port number.

15. The method of claim 10, wherein step (a) further includes the step of:
a1) selecting a type of protocol.

16. The method of claim 10, wherein step (a) further includes the step of:
a1) selecting which of the plurality of probes are to monitor the flow.

17. The method of claim 10, wherein step (d) further includes the step of:
d1) determining a time the traffic packet was detected.

18. The method of claim 10, wherein step (b) further includes the step of:
b1) transmitting a report queue control information.

19. The method of claim 18, wherein step (b1) further includes the step of:
i) defining a time of day.

20. The method of claim 18, wherein step (b1) further includes the step of:
ii) defining a queue length.

21. The method of claim 18, wherein step (b1) further includes the step of:
iii) defining a discard rule.

22. The method of claim 10, wherein step (d) further includes the step of;
d1) calculating a quality of service with incomplete data.

23. A system for determining a quality of service, comprising:
at least two passive probes attached to at least two network connections in a communication network; and
a collector correlator in communication with the at least two passive probes, the collector correlator determining a flow to be monitored.

24. The system of claim 23, wherein the collector correlator transmits a control information to the at least two passive probes.

25. The system of claim 23, wherein the at least two passive probes transmit a report to the collector correlator.

26. The system of claim 23, wherein the collector correlator measures a jitter.

27. The system of claim 23, wherein the at least two passive probes have a common clock.

28. The system of claim 24, wherein the control information includes a report queue control information.

29. The system of claim 23, wherein the collector correlator is capable of computing a router's quality of service without monitoring any of the network connections connected to the router.
